(19) United States
(12) Patent Application Publication
(10) Pub. No.: US 2025/0290206 A1
(43) Pub. Date: Sep. 18, 2025

(54) CHEMICAL FOULING REMOVAL METHOD FOR POLYMERIZATION PROCESSES

(71) Applicant: Braskem S.A., Camaçari (BR)

(72) Inventors: Élita Cavalli, São Paulo (BR); Dihogenes Adriano Pozzer, São Paulo (BR); Olavo Martins Junior, São Paulo (BR); Alessandra Coelho Silva Lucas, São Paulo City (BR)

(73) Assignee: Braskem S.A., Camaçari (BR)

(21) Appl. No.: 18/910,702

(22) Filed: Oct. 9, 2024

Related U.S. Application Data
(60) Provisional application No. 63/565,104, filed on Mar. 14, 2024.

(51) Int. Cl. C23G 1/12

(52) U.S. Cl. CPC C23G 1/125

(57) ABSTRACT

A chemical fouling removal method to be applied in polymerization processes in an on-line way. Particularly, the method of the present invention is focused on the removal of fouling by adding a fouling removal compound and optionally a fouling removal complex in an intermittent or continuous way in processes of polymerization of alpha-olefins, so as to enable polymer fouling detachment from piping or equipment while preserving operational continuity and product quality.

### FIELD

The present technology is generally related to the chemical fouling removal in polymerization processes. More specifically, it is related to a method of removing fouling by adding a fouling removal compound in an intermittent or continuous way in processes of polymerization of alpha-olefins, so as to enable polymer fouling detachment from piping or equipment while preserving operational continuity and product quality.

### BACKGROUND OF THE INVENTION

Processes for the polymerization of alpha-olefins homopolymers or copolymers having monomer and comonomer units of from 2 to 12 carbon atoms are known to be carried out in slurry and gas phase processes that may comprise loop reactors, continuous stirred tank reactors (CSTR), plug flow reactors (PFR), fluidized bed reactors (FBRs) and gas-phase stirred bed reactors or a combination of. The polymers obtained from these types of processes depend on the catalyst morphology, and a generally encountered problem in polymerization processes is the presence of fine polymer particles which are either introduced in the process by existing fine catalyst particles or derived as a result of breakage of the catalyst itself and also polymer particles breakage.

Such fine polymer particles tend to adhere in the walls of piping, reactors, heat exchanger surfaces and other equipment present in the polymerization plant and thereafter grow by chemical reaction at process steps where catalytic sites are still active. In the process stages where the catalyst is no longer active, these polymer fines can accumulate over time. Heat exchange is an essential unit operation for the polyolefins industry, in particular for heat removal from the exothermic polymerization reaction and for the recovery systems that may include unreacted monomer, comonomer and/or solvent vaporization and distillation columns.

Polyolefin plants suffer high operating costs and operation downtime from lost heat transfer efficiency, piping obstruction and equipment cleaning as result of fouling that occurs during the polymerization process. While fouling can occur by different mechanisms, the more common root cause is the adherence of fine polymer particles that continue reacting in the walls of piping and equipment. In case of great process efficiency loss, operation is made unstable and to return the unit to higher throughput operation and enable the production of high heat exchange demanding polymer grades, such fouled piping and equipment typically need to be removed from service and cleaned mechanically or chemically.

The most common method for cleaning when the said piping or equipment is fouled by the adherence of fine polymer particles that turned into agglomerates and/or polymer layers is mechanical, as hydroblasting for example. Successive mechanical cleanings introduce small grooves in the piping or equipment surfaces that increase the roughness, so that when the said piping or equipment surfaces with higher roughness are exposed to the fine polymer particles, they are more likely to stick and therefore increase the fouling rate.

In this regard, U.S. Pat. No. 11,584,902 B2 discloses the curative process of removal of red oils deposits by adding a cleaning agent comprising one or more esters of fatty acids, preferably fatty acid methyl esters, circulating said agent in an installation subject to fouling by red oils, comprising caustic towers of steam crackers and all downstream units dealing with spent caustic, and removing the mixture of the cleaning agent and the dissolved red oils, wherein red oils are organic polymers that form from the aldol condensation of acetaldehyde in sodium hydroxide solution. Said process is used during maintenance operation, thus said equipment are not or partially not in use.

Patent document U.S. Pat. No. 7,976,640 B2 discloses a method for cleaning heat exchange surfaces wherein the heat exchanger is being used to adjust a temperature of a process fluid flowing therethrough in a refinery unit. The process fluid comprises asphaltenic compounds, wherein at least a portion have precipitated out of the process fluid onto the heat exchange surfaces. The method consists of soaking at least one of the heat exchange surfaces with an oil solvent having Solubility Blending Number (SBN) of at least 80 to dissolve asphaltenic compounds precipitated from the process fluid in the oil solvent, wherein the oil solvent comprises at least fifty percent by volume of a crude oil with a Solubility Blending Number of at least 100 and the remainder of the oil solvent comprising a fraction, wherein the oil solvent is at a temperature of at least 25° C. when in contact with at least one of the heat exchanger surfaces of the heat exchanger removing the oil solvent with dissolved asphaltenic compounds from the heat exchanger and processing the oil solvent with dissolved asphaltenic compounds in the refinery process unit.

Document EP2247376B1 describes a method of preventing or reducing agglomeration and/or accumulation on or around the gas distribution grid in a fluidized-bed vessel wherein the said method comprises introducing one or more scouring balls into the vessel above the gas distribution grid; and carrying out a fluidized-bed process in the presence of said scouring balls, wherein the scouring balls reside on the gas distribution grid under process conditions.

U.S. Pat. No. 7,332,070 B2 discloses a process for preventing or reducing the fouling of a heat exchanger in petrochemical plant or a polyolefin production plant, comprising heat exchangers, intercoolers, liquid phase, and gas phase polymerization, by the addition of a specific non-ionic surfactant intermittently or continuously to a stream, mainly comprising hydrocarbons, prior to the passage through said heat exchanger. Wherein said specific non-ionic surfactant comprises polyoxyalkylene glycols, preferably polyethylene oxide or polypropylene oxide copolymers, with 4 to 15 repeating units for ethylene oxide and from 20 to 50 for propylene oxide.

U.S. Pat. No. 5,410,002 discloses the process of feeding to a gas-phase reactor, producing homopolymers of ethylene and/or copolymers of ethylene with olefins comprising at least one (co)polymerization step in the gas phase, a small amount, between 100 and 2,000 ppm, of a compound capable of reacting with an alkyl aluminum compound and capable of selectively deactivating fine catalyst particles, smaller than 850 μm, without reducing the polymerization yield. However, said compound being capable of reducing electrostatic adhesion and its growth in size at the inner walls of the reactor and heat exchanger, that lead to the formation of hot spots in the reactor and an insulation effect in the heat exchanger. Wherein the compound is selected from 1,4-butanediol, sorbitol, glycerol-monostearate, sorbitan-monooleate, epoxidate linseed oil, epoxidate soya oil and N-alkyl-diethanolamines of the formula CH₃(CH)₃CH₂-N(CH₂CH₂OH)₂, where n is between 6 and 20.

Patent U.S. Pat. No. 11,820,879 B2 teaches a method to form an antistatic complex comprising aluminum stearates. Aluminum soap greases are used as thread and way lubricants (Fuels and Lubricants Handbook: Technology, Properties, Performance, and Testing (2003) 558).

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein generally relate to a chemical fouling removal method for on-line removal of fouling in pipping and/or equipment surfaces in polymerization processes of alpha-olefins homopolymers and/or copolymers having monomer and comonomer units of from 2 to 12 carbon atoms, equipment surfaces in polymerization processes of alpha-olefins, comprising: selecting at least one of a release agent and/or at least one of a non-ionic surfactant to form a fouling removal compound; optionally mixing the fouling removal compound with a hydrocarbon; forming a fouling removal complex by mixing the fouling removal compound, optionally mixed with the hydrocarbon, with at least one alkylaluminum component; and feeding said fouling removal complex into a polymerization medium.

According to one aspect of the present invention, the at least one of the release agent and the non-ionic surfactant are contacted to each other before the mixing with the hydrocarbon. The release agent forms a surface film in the interface polymer-metal by chemisorption.

According to another aspect of the present invention, the step of forming a fouling removal complex by mixing the fouling removal compound with at least one alkylaluminum component occurs by feeding de fouling removal compound and at least one alkylaluminum component directly in the polymerization medium to form the fouling removal complex in situ.

According to still another aspect of the present invention, the at least one releasing agent is an acetylated glyceride, such as acetylated monoglyceride having the structure of R¹(CHOCO₂H)R²CO₂CH₂CH(OCO₂H)CH₂OCO₂H, wherein R¹ and R² are linear alkyl groups having 2-16 carbon atoms, or in more particular embodiments R¹ having 4-8 carbon atoms and R² having 8-12 carbon atoms.

According to a further aspect, the at least one non-ionic surfactant is an ester of fatty acid, such as glycerol esters having the general structure R³CO₂O(CH₂CHOHCH₂)₂OH, wherein R³ is a linear alkyl group having 6-26 carbon atoms, or 12 to 22 in more particular embodiments. In a further embodiment, said non-ionic surfactant having a hydrophilic-lipophilic balance (HLB) between 7 and 14, preferably between 8 and 12.

In one embodiment, the mixing of the at least one of the release agent and/or the at least one non-ionic surfactant with the hydrocarbon is carried out in a continuous stirred reactor or an in-line mixer. Such hydrocarbon is a saturated or unsaturated C₃-C₆ hydrocarbon compound.

In another embodiment, said fouling removal compound is fed into the polymerization medium in a continuously or intermittently way.

According to the method of the present invention, said fouling removal compound is fed in an amount higher than 0.5 g/hm² relative to a surface area of piping and/or equipment of the polymerization medium, preferably from 1-3 g/hm².

Moreover, the at least one release agent is used in a mass ratio ranging from 100:0 to 50:50 relative to an amount of the at least one non-ionic surfactant. The at least one non-ionic surfactant is used in a mass ratio ranging from 1:10 to 1:100, relative to an amount of the at least one alkylaluminum component.

In accordance to another aspect of the present invention, an amount of fouling removal complex is increased in at least 20% by weight when the fouling removal complex is continuously fed in the polymerization medium.

According to the present method, removal of fouling in pipping and/or equipment surfaces reduces a fouling resistance up to a steady state is reached. The steady state of the fouling resistance is reached in a range from 270 to 350 operational hours and the fouling resistance has a profile that varies according to a first region and to a subsequent second region, in which (i) the first region being defined by the first 100 operational hours or up to a fouling removal concentration reaches 210 g/m²; and (ii) the second region being defined by a period ranging from an end of the first region up to the steady state, wherein an amount of the fouling removal complex in second region is reduced up to 50% by weight compared to the first region. The fouling resistance in the first region is 5 times higher than the fouling resistance in the second region.

According to another embodiment of the present invention, a chemical fouling removal method for on-line removal of fouling in pipping and/or equipment surfaces in polymerization processes of alpha-olefins is provided, which comprises: selecting at least one of a release agent and/or at least one of a non-ionic surfactant to form a fouling removal compound; mixing the fouling removal compound with a hydrocarbon; and feeding said fouling removal compound into a polymerization medium.

Other aspects and advantages of the claimed subject matter will be apparent from the following description and the appended claims.

### BRIEF DESCRIPTION OF THE DRAWINGS

FIG. 1 is a flow diagram depicting a method according to another embodiment of the present invention which uses a release agent and a non-ionic surfactant in a polymerization process.

FIG. 2 is a flow diagram depicting a method according to another further embodiment of the present invention which uses a release agent and a non-ionic surfactant in a polymerization process.

FIG. 3 is a flow diagram depicting a method according to an additional embodiment of the present invention which uses a release agent in a polymerization process.

FIG. 4 is a graph showing the effect of the method according to the present invention in the global heat exchange coefficient (U) on a polypropylene polymerization.

FIG. 5 is a graph showing the effect of the method according to the present invention in the reduction of fouling resistance (Rf) over the time on a polypropylene polymerization.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and may be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “chemical fouling removal” refers to the removal of polymer agglomerates or polymer layers by adding a fouling removal compound in the alpha-olefins polymerization plant in specific amounts. Fouling is formed by the adherence of fine polymer in the walls of piping, reactors, heat exchanger surfaces and other equipment present in the alpha-olefins polymerization plant that had grown in size by chemical reaction.

As used herein, the term “fouling removal compound” refers to a compound capable of performing chemical fouling removal. Such compound present properties of surface film formation and/or lubricant. According to the present invention, the fouling removal compound is formed by at least one of a release agent and/or at least one of a non-ionic surfactant mixed to each other, optionally mixed to a hydrocarbon.

As used herein, the term “release agent” refers to a chemical compound capable of forming a surface film in the polymer-metal interface by chemisorption into the polymerization process, and therefore preventing other materials from bonding to surfaces.

As used herein, the term “non-ionic surfactant” refers to any kind of surfactant with its molecule not undergoing ionization when being dissolved in water.

As used herein, the term “fouling removal complex” refers to the complex formed by means of the fouling removal compound. It derives from the reaction products between the fouling removal compound and the at least one alkylaluminum component.

As used herein, the term a “polymerization medium” refers to any type of mediums, including polymerization components in reactors, vessels and any other equipment wherein a polymerization reaction is going to occur.

Fouling generated in surfaces of piping and/or equipment along the alpha-olefins polymerization processes is a widely known problem in the art, which can effectively be reduced or removed by applying the method according to the present invention, generally by carrying out the polymerization process with a fouling removal complex which acts as release agents and lubricants.

It has now been found that chemical fouling removal from piping and/or equipment can be conducted in an on-line way in polymerization processes of alpha-olefins by applying the method according to the present invention.

In this regard, the present invention allows the achievement of several benefits, such as plant reducing downtime, reduced costs associated to the cleaning procedure and damage over time, reduction of cleaning frequency, reduction of labor hours spent with cleaning and maintenance. Moreover, by applying the method according to the present invention, there is no need to submit piping and/or equipment to successive mechanical cleaning—which normally leads to an increase in the roughness over the time—, and, therefore, roughness of said piping and/or equipment are not altered.

According to the present invention, by feeding a fouling removal compound intermittently or continuously in appropriate amounts to a stream in polymerization processes, it is possible to detach fouling from piping and/or equipment while preserving operational continuity and product quality.

The method of the present invention enables partially or totally the gradual detachment of polymer from piping and/or equipment walls in an on-line way. By the application of the said method, the build-up of fouling is identified by the change of behavior from process variables, as for example the decrease of the global heat transfer coefficient, valves output from refrigeration of heating fluids to equipment jackets or heat exchangers shell or tubes, level control, temperature and pressure differential in piping and/or equipment.

Thus, in one aspect, the present invention relates to a method that allows the enablement of the formation of surface films in the metal surface of piping and/or equipment by the adsorption of the fouling removal molecules onto the surface, then providing the formation of an effective barrier against polymer-to-metal contact. Said surface films in the interface polymer-metal act as a release agent reducing or eliminating fouling by the detachment of agglomerates and/or polymer layers.

In one aspect, the present invention relates to a chemical fouling removal method for on-line removal of fouling in piping and/or equipment surfaces in polymerization processes of alpha-olefins having monomer and comonomer units of from 2 to 12 carbon atoms, which counts on the selecting at least one of a release agent and/or at least one of a non-ionic surfactant; optionally mixing the at least one of the release agent and/or the at least one non-ionic surfactant with a hydrocarbon to form a fouling removal compound; forming a fouling removal complex by mixing the fouling removal compound with at least one alkylaluminum component, and feeding (in a continuous or intermittent way) said fouling removal complex into a polymerization medium in certain amounts to selectively deactivate the fine polymer particles. Such method may include feeding higher amounts of fouling removal compound into the polymerization process for chemically reduce or eliminate the fouling.

In another aspect of the present invention, said at least one release agent and/or at least one non-ionic surfactant (contacted or not with a hydrocarbon) reacts with at least one alkylalyminum, so as to form an fouling removal complex that acts as grease lubricant. Such reaction to form the fouling removal complex can be performed in-situ (directly in the polymerization medium) or before feeding the complex to the polymerization medium (in a pre-mix).

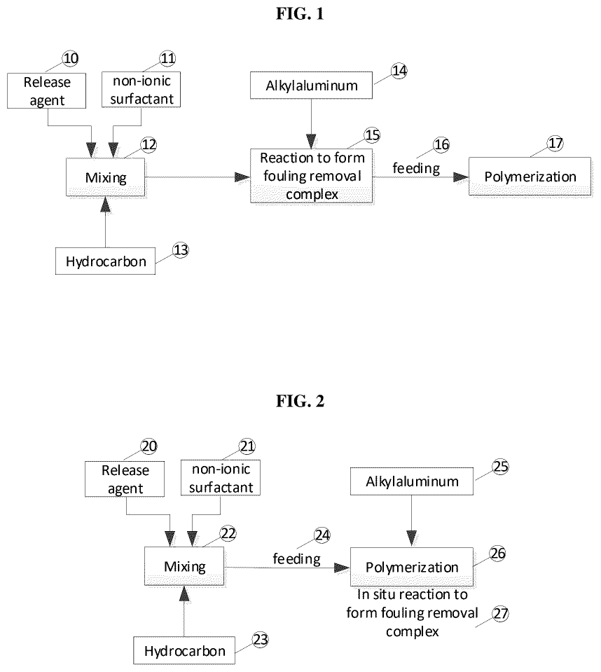

According to an embodiment of the present invention, depicted by FIG. 1, the chemical fouling removal method comprises selecting at least one of a release agent (10) and at least one of a non-ionic surfactant (11), mixing (12) the at least one of the release agent and the at least one non-ionic surfactant with a hydrocarbon (13) to form a fouling removal compound; mixing (15) the fouling removal compound with at least one alkylaluminum component (14) to form a fouling removal complex, which acts as a grease lubrificant; and feeding (16) said fouling removal complex into a polymerization medium (17). Alternatively, the at least one of the release agent and the non-ionic surfactant are contacted to each other before the mixing step with the hydrocarbon.

According to another embodiment of the present invention, depicted by FIG. 2, the chemical fouling removal method comprises selecting at least one of a release agent (20) and at least one of a non-ionic surfactant (21), mixing (22) the at least one of the release agent and the at least one non-ionic surfactant with a hydrocarbon (23) to form a fouling removal compound; feeding (24) said fouling removal compound into a polymerization medium (26) together with at least one alkylaluminum component (25) to form a fouling removal complex in situ. Alternatively, the at least one of the release agent and the non-ionic surfactant are contacted to each other before the mixing step with the hydrocarbon.

According to a further embodiment of the present invention, a chemical fouling removal method comprises selecting at least one of a release agent and/or at least one of a non-ionic surfactant; mixing the at least one of the release agent and/or the non-ionic surfactant with at least one alkylaluminum component to form a fouling removal complex; and feeding said complex into a polymerization medium. Such at least one alkylaluminum component can be premixed with the least one of a release agent and/or at least one of a non-ionic surfactant or mixed in situ in the polymerization medium. Such embodiment does not count on the mixing step of the at least one of a release agent and/or at least one of a non-ionic surfactant with a hydrocarbon, which is an optional step in the method according to the present invention.

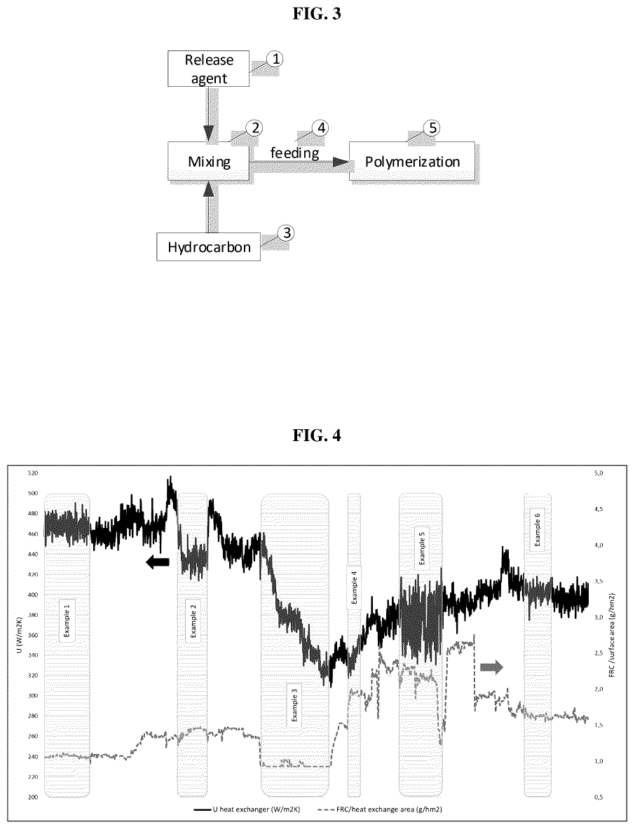

According to still another embodiment of the present invention, depicted by FIG. 3, the chemical fouling removal method comprises selecting at least one of a release agent and/or at least one of a non-ionic surfactant (1), mixing (2) the at least one of the release agent and/or the at least one non-ionic surfactant with a hydrocarbon (3) to form a fouling removal compound; and feeding (4) said fouling removal compound into a polymerization medium (5). According to this embodiment, there is no formation of a fouling removal complex. In this regard, it is noted that, although such embodiment leads to a less efficient method, it still is capable of forming a film in the equipment and, therefore, decreases the fouling in a chemically and on-line way.

According to one or more embodiments, an amount of fouling removal compound is fed in a ratio higher than 0.5 g/hm², relative to the surface area of piping and/or equipment, preferably from 1-3 g/hm².

In some embodiments, the fouling removal compound is a mixture of release agents and non-ionic surfactant. In this regard, the at least one release agent is used in a mass ratio ranging from 100:0 to 50:50 relative to an amount of the at least one non-ionic surfactant. The at least one non-ionic surfactant is used in a mass ratio ranging from 1:10 to 1:100, relative to an amount of the at least one alkylaluminum component.

In some embodiments, the at least one release agent and/or the at least one non-ionic surfactant is mixed with at least one hydrocarbon compound in a mass ratio ranging from about 1:10 to about 9:10, relative to an amount of the hydrocarbon compound. Such hydrocarbon compound is a saturated or unsaturated C₃-C₆ hydrocarbon.

According to the present invention, the at least one release agent includes acetylated glycerides, such as acetylated monoglyceride having the general structure R¹(CHOCO₂H)R²CO₂CH₂CH(OCO₂H)CH₂OCO₂H, wherein R¹ and R² are linear alkyl groups having 2-16 carbon atoms, or in more particular embodiments R¹ has 4-8 carbon atoms and R² has 8-12 carbon atoms. Preferably, the release agent is an acetylated glyceride, more preferably an acetylated monoglyceride.

According to the present invention, the at least one non-ionic surfactant includes polyglycerol esters, such as glycerol esters having the general structure R³CO₂O(CH₂CHOHCH₂)₂OH, wherein R³ is a linear alkyl group having 6-26 carbon atoms, or 12 to 22 in more particular embodiments. In a further embodiment, said “non-ionic surfactant” present a hydrophilic-lipophilic balance between 7 and 14, or 8 and 12 in more particular embodiments. Preferably, the non-ionic surfactant is an ester of fatty acid.

In one or more embodiments, methods in accordance with the present invention may use release agents and non-ionic surfactants that are approved by a governmental regulatory body for use in a particular application, such as in one or more of the food and medical industries. In one or more embodiments, the release agent and non-ionic surfactant can be selected from those that are listed in 21 C.F.R. 178.3130 as being approved by the U.S. Food and Drug Administration for use in food-packaging materials. In one or more embodiments, release agents may include acetylated glycerides approved for the food sector and medical applications, such as commercially available Grindsted soft-n-safe marketed by IFF Nutrition & Biosciences. In one or more embodiments, non-ionic surfactants may include glycerol esters of fatty acid approved for the food sector and medical applications, such as commercially available Grindsted O 80D and Grindsted PS432 marketed by IFF Nutrition & Biosciences.

According to the present invention, the at least one alkylaluminum component is tri-ethyl-aluminum.

According to the present invention, the non-ionic surfactant reacts with the alkylaluminum component combined with the release agent, so as to form a lubricant which is more effective for chemical fouling removal than the use of pure release agents (such as acetylated monoglyceride).

Mixing of the at least one of the release agent and/or the at least one non-ionic surfactant with the hydrocarbon is carried out in a continuous stirred reactor or an in-line mixer.

Moreover, in a polymerization process wherein the fouling removal complex is already being used and continuously being fed in the polymerization medium, but still fouling is occurring, an amount of fouling removal complex is increased in at least 20% by weight so the fouling starts to be removed in a chemically and on-line way, without the need of interrupting the process.

The present invention, thus generally described, will be understood more readily by reference to the following examples, which are provided by way of illustration and are not intended to be limiting of the present invention.

### EXAMPLES

For clear understanding of the examples presented hereinafter, some definitions are provided as follows.

Global heat exchange coefficient (U) indicates the heat exchange capacity of a certain equipment. It is related to the thermal load, heat exchange area, temperatures, flowrates and calorific capacity of the involved fluids. The U is described as:

$$Q = UA \frac{{( {T}_{h} - {T}_{c} )}_{2} - {( {T}_{h} - {T}_{c} )}_{1}}{ln \frac{{( {T}_{h} - {T}_{c} )}_{2}}{{( {T}_{h} - {T}_{c} )}_{1}}}$$

wherein where Q is the heat exchanged, Th is temperature of the hot fluid, Tc is the temperature of the cold fluid and A is the heat exchange area.

Fouling resistance (R_{f}) denotes the heat exchange resistance caused by the undesirable accumulation of polymer agglomerates of polymer layers. The R_{f} is related to the global heat exchange coefficient (U) in the following:

$$\frac{1}{{U}_{d}} = \frac{1}{{U}_{c}} + {R}_{f}$$

wherein where U_{d} is the U dirty, U_{c} is the U clean.

Fouling resistance rate (R_{f} rate) denotes the reduction rate of heat exchange resistance caused by the undesirable accumulation of polymer agglomerates of polymer layers along the time. The fouling resistance rate (R_{f} rate) is defined as:

$${R}_{f} rate = \frac{{R}_{ft = 0} - {R}_{ft}}{t}$$

where R_{ft=0} is the Rf at t=0, U_{c} is the U clean R_{ft} is the R_{f} at t and t is the time of the method of the present invention.

Fouling removal compound concentration (FRC_{conc}) is the mass of fouling removal compound accumulated along the time of the method of the present invention by piping or equipment surface area. The fouling removal compound concentration (FRC_{conc}) is described as:

$$F R {C}_{conc} = {\sum }_{t = 0}^{t} ( \frac{{q}_{FRC}}{A} * t )$$

wherein where q_{FRC} is the feed flowrate of fouling removal compound and A is the piping or equipment surface area.

Hidrophilic-Lipophilic balance (HLB) is a measure of the degree of hydrophilicity or lipophilicity for a non-ionic surfactant according to Griffin's method (Griffin, William C. (1954), “Calculation of HLB Values of Non-Ionic Surfactants”, Journal of the Society of Cosmetic Chemists, 5 (4): 249-561 and Griffin, William C. (1949), “Classification of Surface-Active Agents by ‘HLB’”, Journal of the Society of Cosmetic Chemists, 1 (5): 311-261.), described as:

$$H L B = 20 * \frac{{M}_{h}}{M}$$

wherein Mₕ is the molecular mass of the hydrophilic portion of the molecule and M is the molecular mass of the whole molecule.

Example 1 (comparative). 32,364 kg/h of polypropylene heterophasic copolymer containing 8% of bounded ethylene (C₂) were prepared by polymerizing propylene-ethylene using tri-ethyl-aluminum (TEAL) as cocatalyst and a mixture of acetylene monoglyceride as release agent (which is glycerides, castor-oil mono, hydrogenated, acetates (CAS No. 736150-63-3)) and an ester of fatty acid as non-ionic surfactant (which is an oleic acid monoester with oxybis(propanediol) (CAS No. 49553-76-6)) as fouling removal compound, which was fed directly in the polymerization medium to form a complex with TEAL in situ, specifically upstream the cycle gas heat exchanger from a fluidized bed reactor (FBR). The mixture of acetylene monoglyceride and an ester of fatty acid was fed continuously in a mass ratio of 50:50. The ratio of fouling removal compound in relation to the cycle gas heat exchanger area was 1.06 g/hm². The molar ratio of ester of fatty acid to TEAL was 1:52.7. The resulted U (global heat exchange coefficient) was 467.4 W/m₂K according to Table 1 and FIG. 4.

Example 2 (comparative). Example 1 procedure was repeated, but with a plant average production rate of 26,692 kg/h to produce polypropylene heterophasic copolymer containing 14.2% of bounded ethylene, the ratio of fouling removal compound in relation to the cycle gas heat exchanger area was 0.93 g/hm² and the molar ratio of ester of fatty acid to TEAL was 1:63.4. It was observed a severe drop in the U (global heat exchange coefficient) from 439.7 to 318.2 W/m²K indicating loss of heat exchange capacity due to fouling Generation, as demonstrated in Table 1 and FIG. 4.

Example 3 (fouling increase). Example 1 procedure was repeated except by the plant average production rate, which was 26,692 kg/h to produce polypropylene heterophasic copolymer containing 14.2% of bounded ethylene, the ratio of fouling removal compound in relation to the cycle gas heat exchanger area was 0.93 g/hm² and the molar ratio of ester of fatty acid to TEAL was 1:63.4. It was observed a severe drop in the U (global heat exchange coefficient) from 439.7 to 318.2 W/m²K indicating loss of heat exchange capacity due to fouling generation, according to Table 1 and FIG. 4.

Example 4 (fouling reduction). Example 1 was repeated with an average production rate of 43,796 kg/h to produce polypropylene heterophasic copolymer containing 7% of bounded ethylene, the ratio of fouling removal compound in relation to the cycle gas heat exchanger area was 1.91 g/hm² and the molar ratio of ester of fatty acid to TEAL was 1:43.4. It was observed the gradual increase in the U (global heat exchange coefficient) from 320.3 to 354.5 W/m²K indicating that fouling was being removed from heat exchange surfaces according to Table 1 and FIG. 4.

Example 5 (fouling reduction). Example 1 procedure was repeated with a plant average production rate of 29,774 kg/h to produce polypropylene heterophasic copolymer containing 4% of bounded ethylene, the ratio of fouling removal compound in relation to the cycle gas heat exchanger area was 2.1 g/hm² and the molar ratio of ester of fatty acid to TEAL was 1:24.9. It was observed the gradual increase in the U (global heat exchange coefficient) to an average of 376.5 W/m²K indicating that fouling was being removed from heat exchange surfaces over time, as shown in Table 1 and FIG. 4.

Example 6 (fouling reduction). Example 1 procedure was repeated with a plant average production rate was 37,030 kg/h to produce polypropylene heterophasic Copolymer containing 8% of bounded ethylene, the ratio of fouling removal compound in relation to the cycle gas heat exchanger area was 1.62 g/hm² and the molar ratio of ester of fatty acid to TEAL was 1:45.3. It was observed the gradual increase in the U (global heat exchange coefficient) to an average of 402.1 W/m²K indicating that fouling was being removed from heat exchange surfaces over time, as shown in Table 1 and FIG. 4.

TABLE 1
Experimental conditions of Examples 1-6.

| | Plant | | | | | | | |
|---|---|---|---|---|---|---|---|---|
| | average | | | FRC/surface | acetylated | | U (global heat | |
| | production | C2 | FRC/surface | area standard | monoglyceride/ester | ester of fatty | exchange | U standard |
| | rate | bounded | area | deviation | of fatty acid | acid/TEAL | coefficient) | deviation |
| Units | kg/h | % wt | g/hm² | g/hm² | wt | molar | W/m²K | W/m²K |
| Example 1 | 32,364 | 8 | 1.06 | 0.019 | 50:50 | 1:52.7 | 467.4 | 8.9 |
| Example 2 | 42,826 | 7.8 | 1.41 | 0.058 | 50:50 | 1:59.6 | 436.9 | 11.1 |
| Example 3 | 26,692 | 14.2 | 0.93 | 0.026 | 50:50 | 1:63.4 | 439.7 to 318.2 | — |
| Example 4 | 43,796 | 7 | 1.92 | 0.061 | 50:50 | 1:43.4 | 320.3 to 354.5 | — |
| Example 5 | 29,774 | 4 | 2.1 | 0.27 | 50:50 | 1:24.9 | 376.6 | 24.1 |
| Example 6 | 37,030 | 8 | 1.62 | 0.029 | 50:50 | 1:45.3 | 402.1 | 6.9 |

It is clear that the fouling resistance is an important property in determining whether certain chemical compound may be successfully used as a fouling removal compound (or fouling removal complex) in a polymerization process.

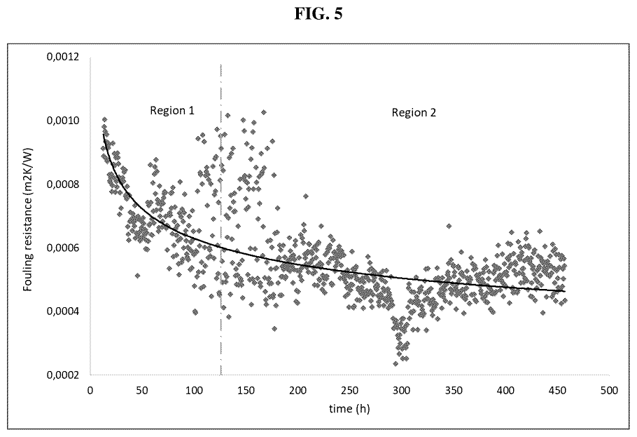

In Example 3, the fouling resistance of the said cycle gas heat exchanger had a severe increase from 0.00027 to 0.00112 m²K/W in the period of 128 hours. Subsequently, the amount of fouling removal compound was increased over the time based on the said cycle gas heat exchange surface area according to Examples 4 to 6 (Table 1 and FIG. 4). The fouling resistance drop was found to be non-linear with the time according to FIG. 5 where no significant reduction in the R_{f} was observed after 302 hours.

By applying the methods according to the present invention, it is observed that the fouling resistance has a profile that varies according to a first region and to a subsequent second region (as showed by Table 2), in which the first region is defined by the first 100 operational hours or up to a fouling removal concentration reaches 210 g/m²; and the second region is defined by a period ranging from an end of the first region up to the steady state, wherein an amount of the fouling removal complex in second region is reduced up to 50% by weight compared to the first region. In this regard, the fouling resistance in the first region is 5 times higher than the fouling resistance in the second region.

The rate of change of fouling resistance (R_{f} rate) was higher for the first 100 hours where the R_{f} was reduced from 0.00112 to 0.00063 m²K/W. For this first region (FIG. 5, Table 2), the mechanism for fouling removal was dominated by the ratio of the amount of fed fouling removal compound relative to the surface area. Between time 100 and 302 hours, the R_{f} was reduced more reaching an average of 0.0005 m²K/W. For the second region (FIG. 5, Table 2), the mechanism is showed to be cumulative and time dominant where just the increase in the ratio of the amount of fed fouling removal compound relative to the surface area is not sufficient for effective fouling removal. In FIG. 4 (between Example 5 and 6) is showed an increase in the ratio of the amount of fed fouling removal compound relative to the surface area to 2.6 g/hm² in an attempt to accelerate the reduction of R_{f}, but the results indicated much lower rate of change of fouling resistance (Rf rate) comparing to region 1. While certain embodiments have been illustrated and described, it should be understood that changes and modifications may be made therein in accordance with ordinary skill in the art without departing from the technology in its broader aspects as defined in the following claims.

TABLE 2
Fouling resistance profile

| Re- | | Dominant | Fouling resistance |
|---|---|---|---|
| gion | Equation | mechanism | rate (R_{f} rate) |
| 1^{st} | ${R}_{f} = 0.0016 * {( {\sum }_{t = 0}^{t} ( \frac{{q}_{FRC}}{A} * t ) )}^{- 0.173}$ | fouling removal compound feed by surface area | for t = 0 to 100 h 4.9E−06 m²K/W/h |
| 2^{nd} | R_{f} = 0.0016 * t^{-0.202} | time | for t = 100 to 302 h |
| | | | (or to steady state) |
| | | | 6.2E−07 m²K/W/h |

According to the present invention, removal of fouling in piping and/or equipment surfaces reduces a fouling resistance up to a steady state is reached. In this regard, the steady state of the fouling resistance is reached in a range from 270 to 350 operational hours.

Moreover, it is noted that by using the methods according to the present invention in a heat exchange, the fouling resistance is reduced by at least 40% based on the fouling resistance when chemical fouling removal starts.

As can be seen from Examples 4 to 6, which correspond to methods according to the present invention, the heat exchange capacity (measured by U) of the said cycle gas heat exchanger was recovered from 320.3 to 403 W/m²K reaching the steady state at 85.6% of the heat exchange capacity disclosed on Example 1. The application of the present method enabled the increase of the cycle gas heat exchanger campaigns in 325% up to now, comparing to the history of the said heat exchanger in the past 10 years.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations may be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like, include the number recited and refer to ranges which may be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A chemical fouling removal method for on-line removal of fouling in piping and/or equipment surfaces in polymerization processes of alpha-olefins, comprising:
selecting at least one of a release agent and/or at least one of a non-ionic surfactant to form a fouling removal compound;
optionally mixing the fouling removal compound with a hydrocarbon;
forming a fouling removal complex by mixing the fouling removal compound, optionally mixed with the hydrocarbon, with at least one alkylaluminum component;
and
feeding said fouling removal complex into a polymerization medium.

2. The process of claim 1, wherein the at least one of the release agent and the non-ionic surfactant are contacted to each other before the mixing with the hydrocarbon.

3. The process of claim 1, wherein forming a fouling removal complex by mixing the fouling removal compound with at least one alkylaluminum component occurs by feeding de fouling removal compound and at least one alkylaluminum component directly in the polymerization medium to form the fouling removal complex in situ.

4. The process of claim 1, wherein the release agent forms a surface film in the interface polymer-metal by chemisorption.

5. The process of claim 1, wherein the polymerization processes of alpha-olefins comprise polymerization of alpha-olefins homopolymers and/or copolymers having monomer and comonomer units of from 2 to 12 carbon atoms.

6. The process of claim 1, wherein the at least one releasing agent is an acetylated glyceride, such as acetylated monoglyceride having the structure of R¹(CHOCO₂H)R₂CO₂CH₂CH(OCO₂H)CH₂OCO₂H, wherein R¹ and R² are linear alkyl groups having 2-16 carbon atoms, or in more particular embodiments R¹ having 4-8 carbon atoms and R² having 8-12 carbon atoms.

7. The process of claim 1, wherein the at least one non-ionic surfactant is an ester of fatty acid, such as glycerol esters having the general structure R³CO₂O(CH₂CHOHCH₂)₂OH, wherein R³ is a linear alkyl group having 6-26 carbon atoms, or 12 to 22 in more particular embodiments. In a further embodiment, said non-ionic surfactant having a hydrophilic-lipophilic balance (HLB) between 7 and 14, preferably between 8 and 12.

8. The process of claim 1, wherein the mixing of the at least one of the release agent and/or the at least one non-ionic surfactant with the hydrocarbon is carried out in a continuous stirred reactor or an in-line mixer.

9. The process of claim 1, wherein the hydrocarbon is a saturated or unsaturated C₃-C₆ hydrocarbon compound.

10. The process of claim 1, wherein said fouling removal compound is fed into the polymerization medium in a continuously or intermittently way.

11. The process of claim 1, wherein said fouling removal compound is fed in an amount higher than 0.5 g/hm² relative to a surface area of piping and/or equipment of the polymerization medium, preferably from 1-3 g/hm².

12. The process of claim 3, wherein the at least one alkylaluminum component is tri-ethyl-aluminum.

13. The process of claim 1, wherein the at least one release agent is used in a mass ratio ranging from 100:0 to 50:50 relative to an amount of the at least one non-ionic surfactant.

14. The process of claim 3, wherein the at least one non-ionic surfactant is used in a mass ratio ranging from 1:10 to 1:100, relative to an amount of the at least one alkylaluminum component.

15. The process of claim 10, wherein an amount of fouling removal complex is increased in at least 20% by weight when the fouling removal complex is continuously fed in the polymerization medium.

16. The process of claim 1, wherein removal of fouling in piping and/or equipment surfaces reduces a fouling resistance up to a steady state is reached.

17. The process of claim 16, wherein the steady state of the fouling resistance is reached in a range from 270 to 350 operational hours.

18. The process of claim 16, wherein the fouling resistance has a profile that varies according to a first region and to a subsequent second region, in which
the first region being defined by the first 100 operational hours or up to a fouling removal concentration reaches 210 g/m²; and
the second region being defined by a period ranging from an end of the first region up to the steady state,
wherein an amount of the fouling removal complex in second region is reduced up to 50% by weight compared to the first region.

19. The process of claim 18, wherein the fouling resistance in the first region is 5 times higher than the fouling resistance in the second region.

20. A chemical fouling removal method for on-line removal of fouling in piping and/or equipment surfaces in polymerization processes of alpha-olefins, comprising:
selecting at least one of a release agent and/or at least one of a non-ionic surfactant to form a fouling removal compound;
mixing the fouling removal compound with a hydrocarbon; and
feeding said fouling removal compound into a polymerization medium.
